(19) United States
(12) Patent Application Publication
(10) Pub. No.: US 2016/0267403 A1
(43) Pub. Date: Sep. 15, 2016

(54) Networked Style Logistics

(71) Applicant: Hair Construction, Inc., Miami Beach, FL (US)

(72) Inventors: Cory HOFFART, Miami Beach, FL (US); Magdalene PALFI, Miami Beach, FL (US); Palle FREESE, Kolding (DK)

(21) Appl. No.: 15/161,802

(22) Filed: May 23, 2016

Related U.S. Application Data
(63) Continuation of application No. PCT/US14/66963, filed on Nov. 21, 2014.
(60) Provisional application No. 61/907,811, filed on Nov. 22, 2013.

(51) Int. Cl. G06Q 10/02; H04W 4/02; G06Q 10/06; G06F 17/30

(52) U.S. Cl. CPC G06Q 10/02; G06F 17/3028; H04W 4/02; G06Q 10/06311

(57) ABSTRACT

Systems and methods here include embodiments for booking a stylist, including using a computer server in communication with a data storage and a network. The computer server for receiving a plurality of style photos, categorizing the received style photos, causing storage of the received categorized style photos in the data storage, receiving indications from a plurality of stylists for the stored photos, correlating, via the data storage, each stylist and their indicated photos, receiving a valid log-in credential and a current geographic location from a customer user mobile device via the network, sending the customer user a menu of style categories, receiving a category selection from the customer user, sending the customer user mobile device the categorized photos to view corresponding to the category selection, receiving, from the customer user mobile device via the network, a selection of one of the categorized photos.

### RELATED CASES

This application claims priority to PCT/US14/66963 filed 21 Nov. 2014 which in turn claims priority to U.S. Provisional Application 61/907,811 filed 22 Nov. 2013 both of which are hereby incorporated in their entirety.

### TECHNICAL FIELD

This application relates to the field of networked communications, aggregation of and dissemination of style and promotion information and coordination of bookings.

### BACKGROUND

Currently, many people go to a salon and request a hairstyle, or ‘look’, based on a picture of a celebrity taken out of a magazine. A stylist is then tasked with replicating that look for a client, no matter the stylist's level of training or complexity of the hairstyle. This presents the problem that a client's expectations may not match the stylist's skill. Furthermore, the picture provided of the celebrity look is a flat, two-dimensional photo, and does not provide either a complete view of the hairstyle around the entire head or instructions on how to create the desired look for the client.

### SUMMARY

Systems and methods here may include embodiments for booking a stylist, including, via a server in communication with a data storage and a network, receiving a plurality of style photos, categorizing the received style photos, causing storage of the received categorized style photos in the data storage, receiving indications from a plurality of stylists for the stored photos, correlating, via the data storage, each stylist and their indicated photos, receiving a valid log-in credential and a current geographic location from a customer user mobile device via the network, sending the customer user a menu of style categories, receiving a category selection from the customer user, sending the customer user mobile device the categorized photos to view corresponding to the category selection, receiving, from the customer user mobile device via the network, a selection of one of the categorized photos, sending the customer user mobile device information for the plurality of stylists correlated to the selected photo, receiving from the customer user mobile device via the network, a selection of a stylist from the plurality of stylists correlated to the selected photo, and sending the selected photo to the selected stylist via the network. Some embodiments may include causing storage, in the data storage, of a hair recipe corresponding to each received stored photo. And in some, the hair recipe includes at least one of, a name, a video, a diagram and a text instruction. Certain example embodiments include sending to the selected stylist via the network, the hair recipe corresponding to the selected photo. And some embodiments include directing a browser, run on the customer user mobile device, to a booking website for the selected stylist, via the network. In some embodiments, the systems and methods include correlating, via the data storage, the received stored photos and a corresponding style product information, and sending the customer user mobile device the corresponding style product information correlated to the selected photo.

Some embodiments include determining the plurality of stylists based on a proximity to the user mobile device current geographic location. And in some embodiments, the systems and methods include sending the selected photo to a social network website designated by the customer user. In some embodiments, the selected photo may include a tag with an indication of a product used for the selected style.

In some embodiments, the systems and methods include sending the customer user mobile device information regarding the ability to purchase the product tagged to the selected photo. And in some embodiments, the systems and methods include sub-categorizing the received style photos, sending the customer user a menu of style sub-categories, receiving a sub-category selection from the customer user, and sending the customer user mobile device the sub-categorized photos to view. In some embodiments, the style photos are accompanied by style videos.

In certain example embodiments, the systems and methods include receiving new photos from customer users via the network categorizing the received new photos, and causing storage of the categorized new photos in the data storage. In certain embodiments, they include receiving profile information from the plurality of stylists via the network, causing storage of the profile information from the plurality of stylists. Certain embodiments include receiving profile information from the customer user of the mobile device, causing storage of the profile information from the customer user.

The systems and methods here may include embodiments for booking a stylist, including, via a server in communication with a data storage and a network, receiving a plurality of style photos and corresponding hair recipes, categorizing the received style photos, causing storage of the received categorized style photos and corresponding hair recipes in the data storage, correlating, via the data storage, the received stored photos and a corresponding style product information, receiving a valid log-in credential and a current geographic location from a user mobile device via the network, sending the user a menu of style categories, receiving a category selection from the user, sending the user mobile device the categorized photos to view, receiving, from the user mobile device via the network, a selection of one of the categorized photos, sending, via the network, the selected categorized photos and corresponding hair recipe to a plurality of stylists within geographic proximity to the user current geographic location, receiving from a subset of the plurality of stylists, a positive indication on the selected photo and available times, sending the received subset of the plurality of stylists and received available times to the user mobile device, and receiving, via the network, a selection from the mobile user device for one of the subset of the plurality of stylists and a selection of an available time.

In some embodiments, the hair recipe includes at least one of, a name, a video, a diagram and a text instruction. And some embodiments are further comprising, via the server in communication with the data storage and the network, sending the hair recipe corresponding to the selected photo to the selected stylist via the network. Certain embodiments include directing a browser run on the user mobile device, to a booking website for the selected stylist, via the network. And some embodiments include sending the user mobile device the corresponding style product information correlated to the selected photo.

In some embodiments, the systems and methods include determining the plurality of stylists based on a proximity to the user mobile device current geographic location. And in some embodiments, they include comprising, via the server in communication with the data storage and the network, sending the selected photo to a social network website designated by the user.

Systems and methods here may include embodiments with a computer server in communication with a data storage and a network, the computer server configured to, receive a plurality of style photos and corresponding hair recipes, categorize the received style photos, cause storage of the received categorized style photos and corresponding hair recipes in the data storage, correlate, via the data storage, the received stored photos and a corresponding style product information, receive a valid log-in credential and a current geographic location from a user mobile device via the network, send the user a menu of style categories, receive a category selection from the user, send the user mobile device the categorized photos to view, receive, from the user mobile device via the network, a selection of one of the categorized photos, send, via the network, the selected categorized photos and corresponding hair recipe to a plurality of stylists within geographic proximity to the user current geographic location, receive from a subset of the plurality of stylists, a positive indication on the selected photo and available times, send the received subset of the plurality of stylists and received available times to the user mobile device, and receive, via the network, a selection from the mobile user device for one of the subset of the plurality of stylists and a selection of an available time. Some embodiments the computer server is further configured to, direct a browser run on the user mobile device, to a booking website for the selected stylist, via the network, and in some send the user mobile device the corresponding style product information correlated to the selected photo.

Some example systems and methods of arranging a reservation described here include, via a server in communication with a data storage and a network, receiving a plurality of reservation photos from vendors via the network, categorizing the received reservation photos, causing storage of the received categorized reservation photos in the data storage, correlating the vendor who submitted the reservation photo to vendor information in the data storage, receiving a valid log-in credential and a current geographic location from a customer user mobile device via the network, sending the customer user a menu of reservation categories, receiving a category selection from the customer user, sending the customer user mobile device the categorized photos to view corresponding to the category selection, and receiving, from the customer user mobile device via the network, a selection of one of the categorized photos. Some embodiments include, causing storage, in the data storage, of reservation details corresponding to each received stored photo, and in some, sending the customer selection of the categorized photo to the correlated vendor via the network.

Some example systems and methods include a non-transitory computer-readable medium having computer-executable instructions thereon for a method of booking a style, the method comprising, via a server in communication with a data storage and a network, receiving a plurality of style photos, categorizing the received style photos, causing storage of the received categorized style photos in the data storage, receiving indications from a plurality of stylists for the stored photos, correlating, via the data storage, each stylist and their indicated photos, receiving a valid log-in credential and a current geographic location from a customer user mobile device via the network, sending the customer user a menu of style categories, receiving a category selection from the customer user, sending the customer user mobile device the categorized photos to view corresponding to the category selection, receiving, from the customer user mobile device via the network, a selection of one of the categorized photos, sending the customer user mobile device information for the plurality of stylists correlated to the selected photo, receiving from the customer user mobile device via the network, a selection of a stylist from the plurality of stylists correlated to the selected photo, and sending the selected photo to the selected stylist via the network.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1A is an example network diagram, showing an example computer network that could be used to implement the certain example embodiments described here.

FIG. 1B is an example screenshot describing one example method to implement the inventions described here.

FIG. 2A is an example flow chart depicting an example embodiment of how the system may allow for style selection and booking.

FIG. 2B is an example screenshot depicting an example of how the system may allow for style selection and booking according to embodiments herein.

FIG. 2C is an example screenshot depicting an example of how the system may allow for style selection and booking according to embodiments herein.

FIG. 2D is an example screenshot depicting an example of how the system may allow for style selection and booking according to embodiments herein.

FIG. 2E is an example screenshot depicting an example of how the system may allow for style selection and booking according to embodiments herein.

FIG. 2F is an example screenshot depicting an example of how the system may allow for style selection and booking according to embodiments herein.

FIG. 2G is an example screenshot depicting an example of how the system may allow for style selection and booking according to embodiments herein.

FIG. 2H is an example screenshot depicting a history example of how the system may allow for style selection and booking according to embodiments herein.

FIG. 3 is an example screenshot depicting an example of how the system may allow for style selection and booking according to embodiments herein.

FIG. 4 is an example screenshot depicting an example hair recipe according to embodiments herein.

FIG. 5A is another example screenshot depicting an example hair recipe according to embodiments herein.

FIG. 5B is another example screenshot depicting an example hair recipe according to embodiments herein.

FIG. 6 is another example screenshot depicting an example hair recipe according to embodiments herein.

FIG. 7 is an example screenshot depicting an example of how the system may allow for style selection and booking according to embodiments herein.

FIG. 8A is an example screenshot depicting an example of how the system may allow for style selection and booking according to embodiments herein.

FIG. 8B is an example screenshot depicting an example of how the system may allow for style selection and booking according to embodiments herein.

FIG. 9A is an example screenshot depicting an example of how the system may allow for style selection and booking according to embodiments herein.

FIG. 9B is an example screenshot depicting an example of how the system may allow for style selection and booking according to embodiments herein.

FIG. 10A is an example screenshot depicting an example of how the system may allow for style selection and booking according to embodiments herein.

FIG. 10B is an example screenshot depicting an example portfolio according to embodiments herein.

FIG. 10C is another example screenshot depicting an example portfolio according to embodiments herein.

FIG. 10D is another is an example screenshot depicting an example portfolio according to embodiments herein.

FIG. 10E is another example screenshot depicting an example portfolio according to embodiments herein.

FIG. 11 is another example screenshot depicting an example portfolio according to embodiments herein.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the invention to these particular embodiments. In other instances, well-known data structures, timing protocols, software operations, procedures, and components have not been described in detail so as not to unnecessarily obscure aspects of the embodiments of the invention.

### Overview

The present embodiments described herein relate to networking devices, systems and methods for style discovery, style selection and stylist booking, style instruction, sharing product suggestions and purchasing as well as and collaboration. Certain embodiments may include aspects of online education, e-commerce, product consulting, marketing, advertising, scheduling, client generation, and social networking. The present embodiments may attract and engage with users, improve the knowledge and skill level of stylists, and increase the purchasing, management and use of hair products.

The term stylist, client, customer and user are used herein to describe any and all of the following interchangeable groups that include barbers, hairdressers, students, teachers, salon operators, product users, product purchasers, product vendors, people seeking a style and advertisers, without limitation. Further, The terms video, instruction, recipe, step-by-step, how-to, education, hairstyle recipe are all used to describe the information used in performing a style and may be considered interchangeable as well.

It should also be noted that although the system is described in terms of a style and/or hair salon, any of various business endeavors could utilize the systems and methods described here. For example, spas, doctors, dentists, car repair, physical therapy, catering, home repair, construction, or any of various other businesses could utilize these systems and methods to likewise coordinate customers with service providers and geo location systems to book appointments. Thus, the references to salon, stylists, etc. are not intended to be limiting but merely illustrative.

### Example Network

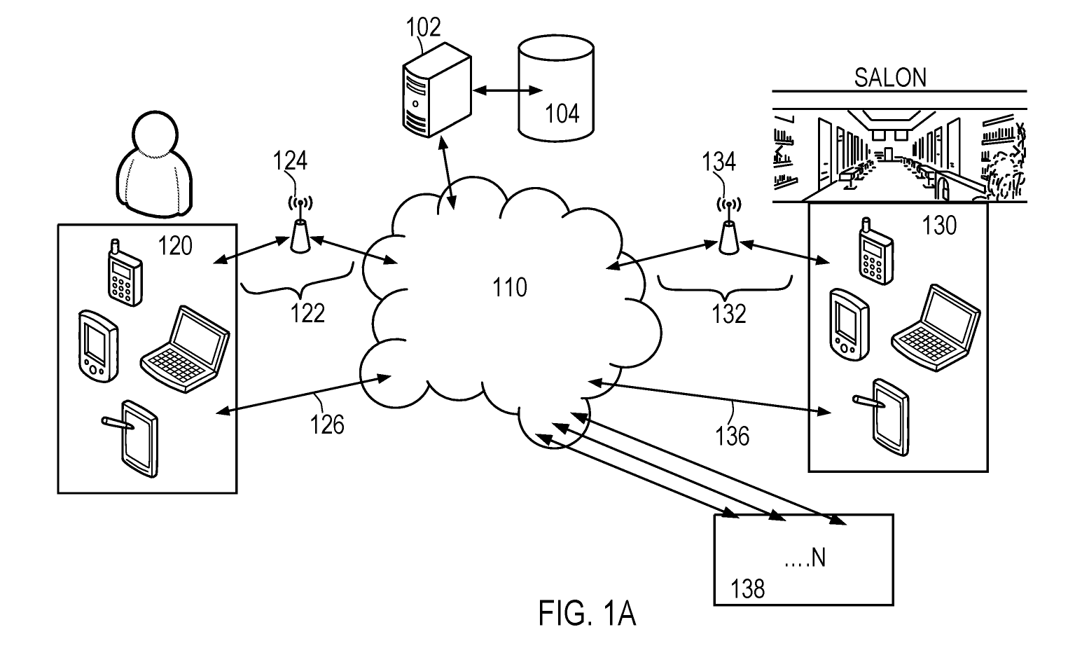

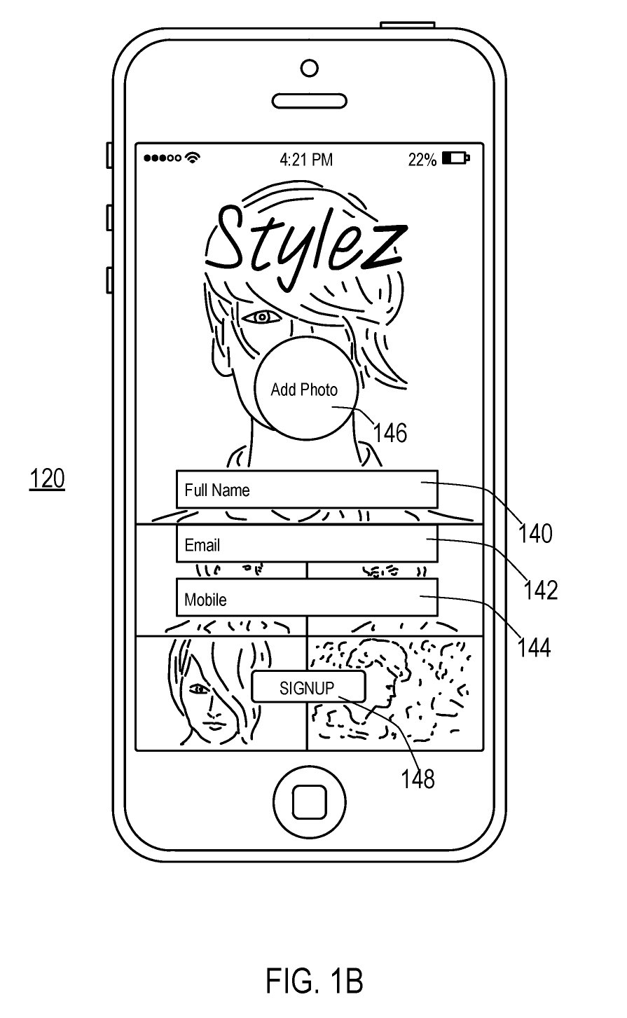

An example network that could be used to implement certain embodiments disclosed here is shown in the diagram of FIG. 1A. In FIG. 1A, the back end computer server system 102 is shown in communication with a data storage 104 such as a database. Such a server system could be any grouping of one or more computers, servers, networked devices with processors, memory, and the capacity to facilitate networks. The data storage 104 could be any kind of local or cloud storage, distributed or centralized, and is shown as a local data storage here for example purposes only. The back end system 102 is also shown in communication with a network 110, such as the internet. The system 102 is able to make the connections between the users 120 and the salons 130, and also cause storage of the hair recipes and the various product information used in the example implementations described here. The system 102 is also configured to correlate.

In some embodiments, the users of the system could use any number of computer user equipment 120 to access the system, log in, search for and coordinate the hair styles, as well as search and complete the bookings. Any number of computing devices such as laptops, desktops, mobile devices such as smartphones, tablets, phablets, wearables, etc. could be used to connect to the network 110 and thereby the back end system 102. The connections could be through any kind of wireless connection 122 through an antenna 124 such as in a WiFi system or cellular system. The computing devices could also be hard wired 126 to the network as well.

On the salon and/or stylist side, according to some embodiments, similar arrangements could allow any number of computer user devices 130 mobile or otherwise to likewise connect to the internet 110 through wireless 132 via an antenna 134 such as WiFi or cellular or any other kind of connection, as well as via a hard wired 136 connections. The hair salons and/or stylists could then access the system, log in, search the recipes, receive bookings, engage in e-commerce and/or promotional opportunities or other information according to the various example embodiments described here. Any number of networked salons and/or stylists could be connected to the system. For example, N number 138 of stylists or salons could be networked in and contribute information and also participate in the network. Likewise, any number of users could access the system as well (not pictured).

It should be noted that such a networked system could allow for many various customer users to log in, view details of styles, communicate with stylists and book appointments, all at the same time, and all over various physical distances by network. Further, the system can provide a geographically localize and limited set of stylists who may perform the style. It may allow for users to communicate to any of the various selected stylists and inform them of the details needed to perform the style implementation that they have selected from the stored selections. In such a way, the system is able to communicate the selected information to the selected recipient via the network, and do so for many users repeatedly in real time.

FIG. 1B shows an example screen shot of a user mobile device 120 which is shown accessing the system 102. In the screenshot, the web browser of the mobile device 120 is receiving information from the back end 102 and displaying it on the mobile device. In FIG. 1B, the system is prompting the user to input a name 140, an email 142 and a mobile phone number 144 in order to sign up to the program to utilize the system. The system may also allow the user to add a photo 146 of themselves. Finally, the user may push the sign up 148 button to sign into the system and begin utilizing the products and/or services. After an initial sign up, the user may establish a login credential and log into the system via a portal that allows access to the back end system 102. In certain examples, a user login may be associated with another website, such as an email provider, social network, company, organization or the like.

### Style Selection and Booking Application

Some embodiments of the invention may provide users with the ability to discover styles and book appointments at a facility that is capable of providing the selected styles. In certain embodiments, these functions are performed on an application running on a mobile device or computer.

Further, in some embodiments, the system may correlate user selections of styles with stylists who are part of the system in some embodiments called Hair Construction, which empowers them to perform these styles via their instructional videos and hairstyle recipes. Furthermore, stylists may have indicated that they are able and willing to perform such a style. Thus, the system can receive a request, correlate that request with a list of geographically nearby stylists who have indicated they are able and willing to perform the style, coordinate a selection of those various stylists with the user, in some embodiments including date/time and cost details, and then coordinate pushing the desired style information to the selected stylist all remotely via the network.

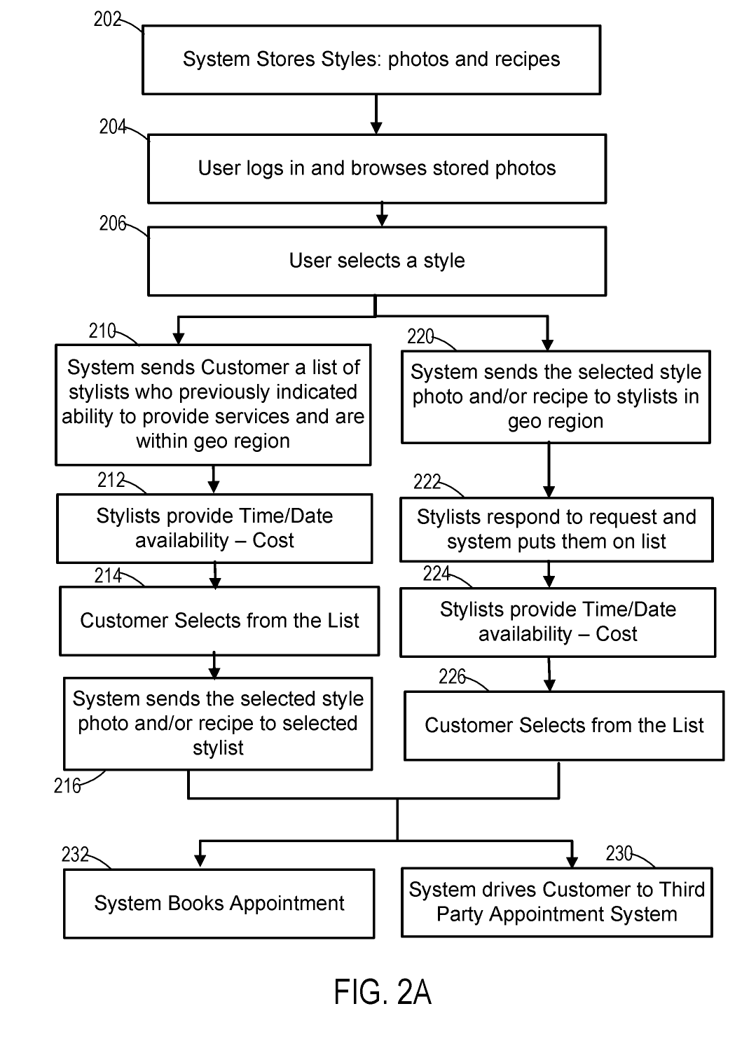

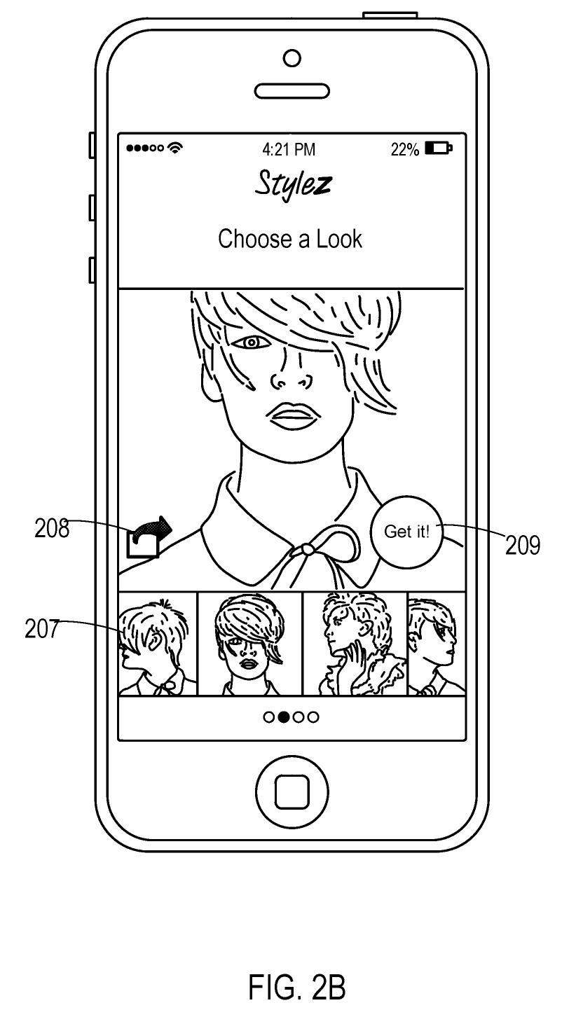

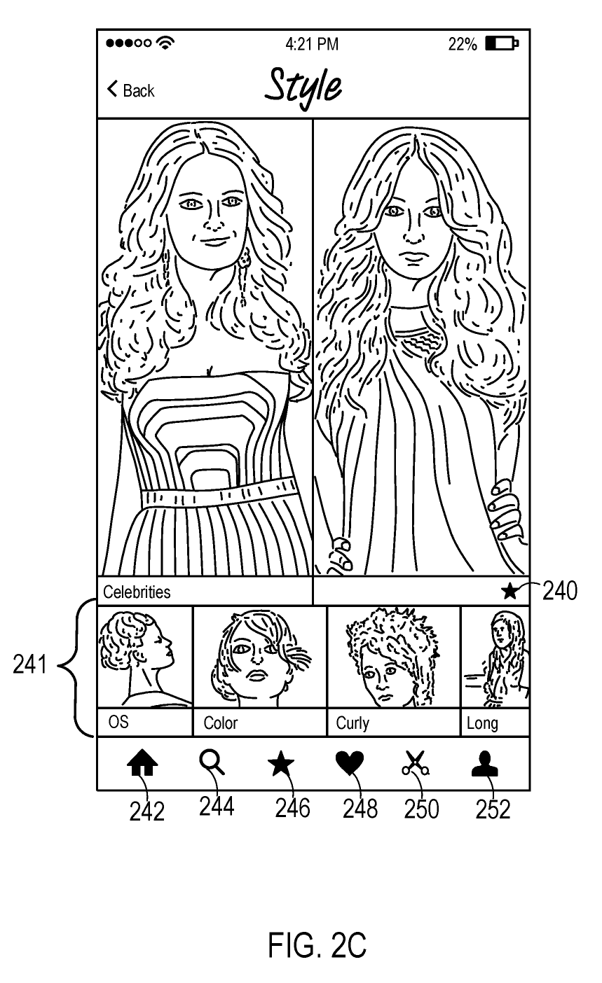

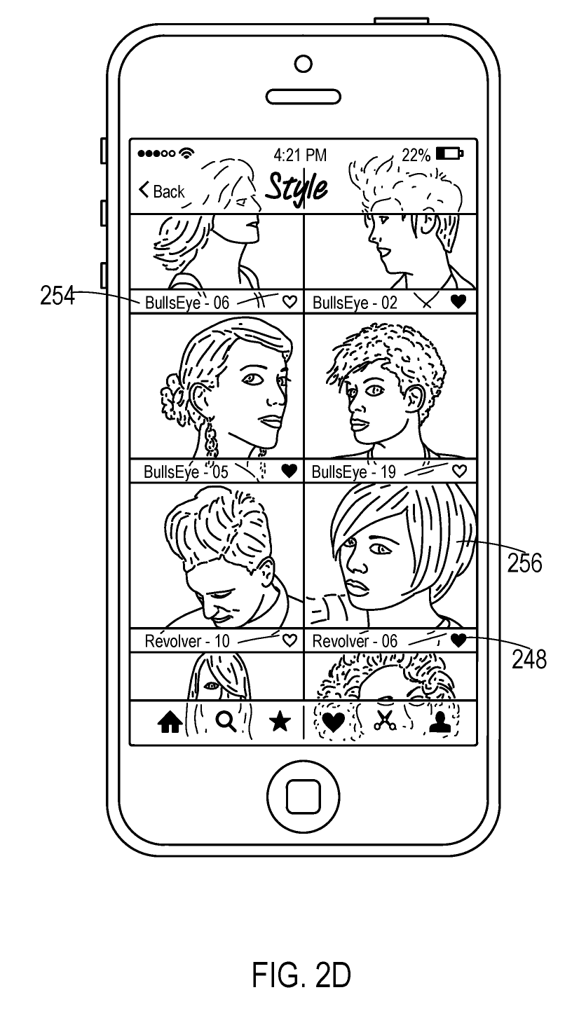

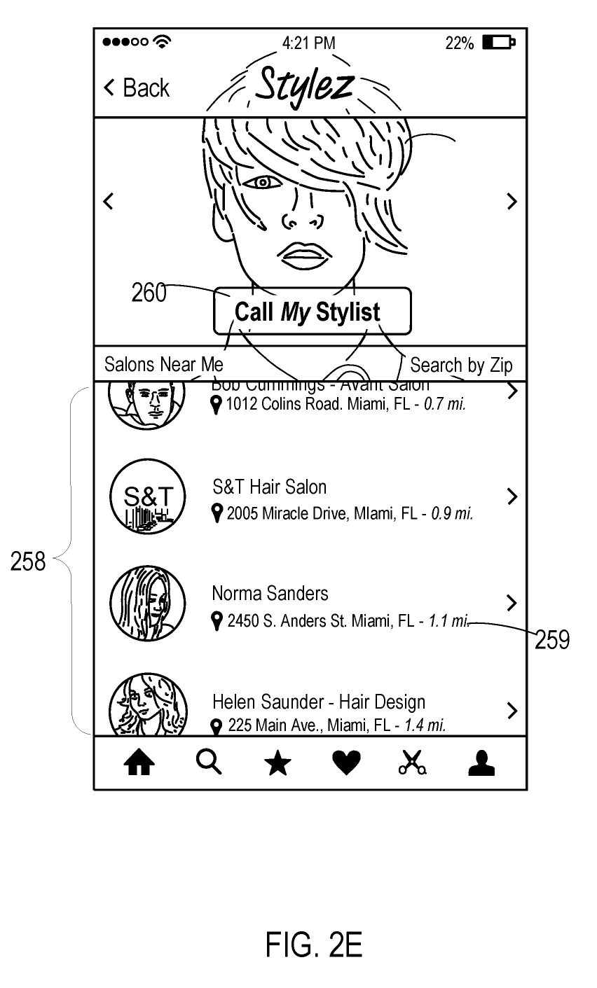

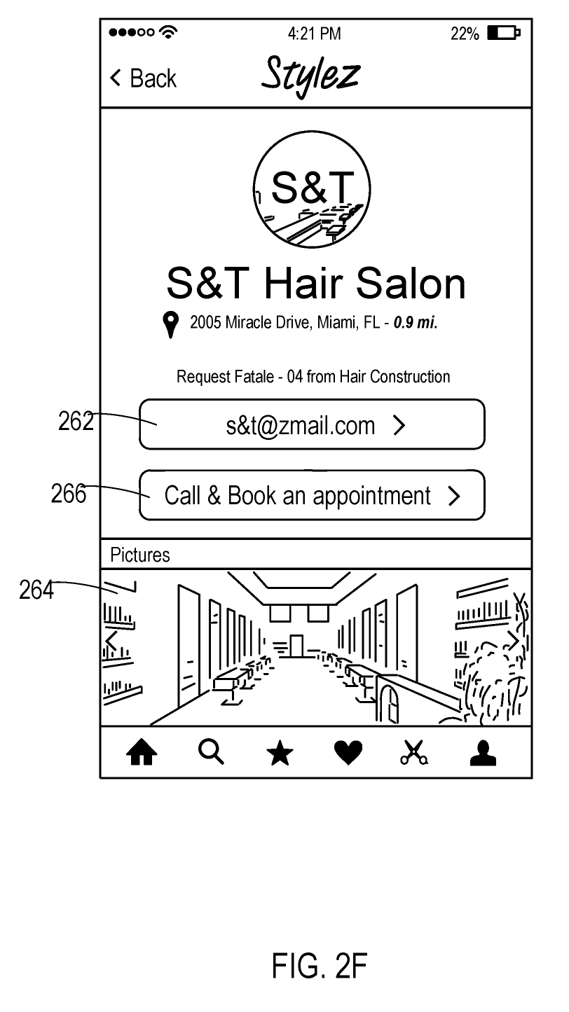

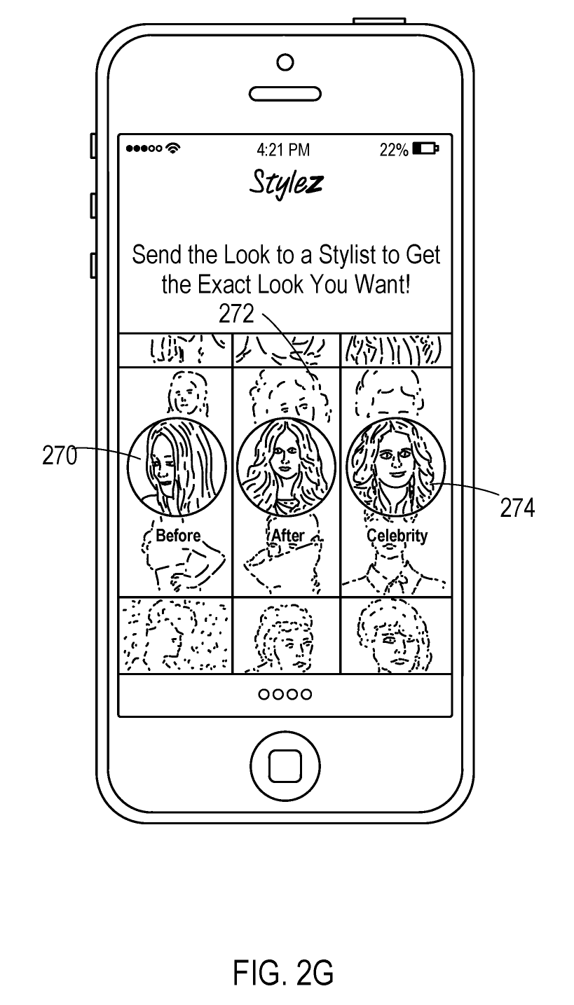

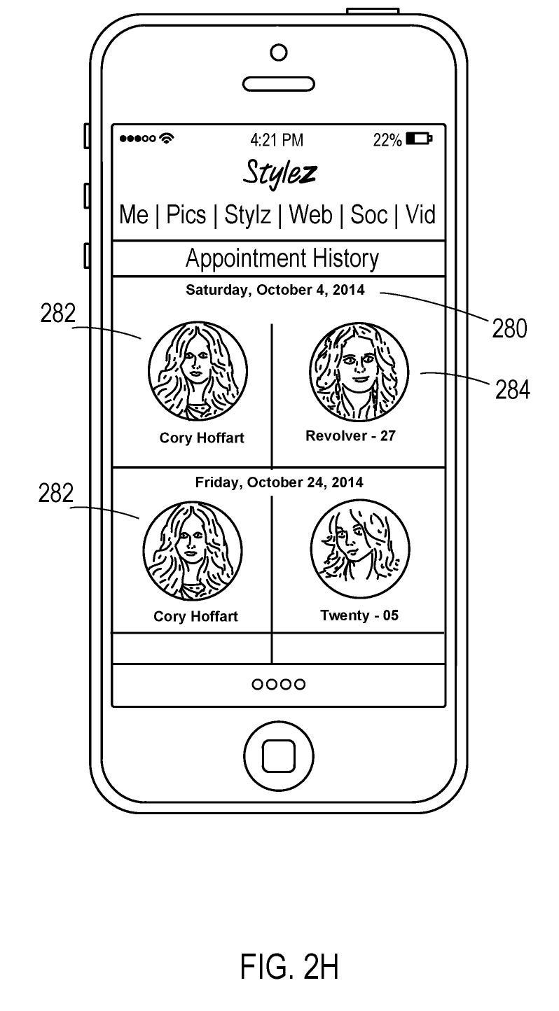

FIG. 2A is an example flow chart depicting an example embodiment of how the system may allow for style selection and booking via the servers, network and mobile user devices. In the example, the system first stores photos and corresponding hair recipes, 202 as explained in detail below. These photos could be populated by the system administrator internally, or be sent by stylists who desire to retain customers who want that style. The recipes could be created by a system administrator to correspond to any of various photos.

Further, such photos may be any kind of hair style for men or women or unisex. The corresponding hair recipe can include any number of tutorials such as step-by-step photos, videos, diagrams, written instruction, audio instruction, etc. to notify a stylist of how to achieve the style. Further, the recipe may include associated features such as cut, color, blow dry, style, products to use, techniques to achieve the style, etc.

In the example flow chart of FIG. 2A, the system may allow a user to log into the system via the network (as shown in FIG. 1B) and browse the stored documents 204 including photos and/or videos of the styles. FIG. 2B shows an example screen shot of a browsing profile on a mobile user device. In FIG. 2A again, while browsing, the user could view a plurality of hairstyles and select a style 206 for which they want to reserve a stylist. More examples are shown in FIG. 2C where various styles in categories are browsed by a user. The system may allow a user to select a style based on any of various features such as those worn by a given celebrity, an Updo, a Color, Curly, Long, etc. The system may allow for a user to indicate a preference for a look by clicking on an icon such as a star 240. The system may allow the user to utilize various navigation buttons to return to the home screen 242, search for a style or stylist using a text box search 244, search previously starred styles 246, search styles that the system is indicating are trending or favorites 248, search stylists 250, and search for other users 252. Another example set of styles a user could browse via the mobile device is shown in FIG. 2D. In this example, the heart indication 248 shows up under certain selections. Also, a name 254 of the style is shown under a photo 256 of the style. Any style or layout of photos and names could be used to browse the system and select a style.

Examples where Stylists Previously Indicates Services

Referring again to FIG. 2A, in some example embodiments, the system can correlate the stored styles with hair salon facilities that have previously indicated that they are able to provide services associated with the selected styles and are within a set geographical region from the user mobile device 210. In such a way, customers who are looking for a specific look may be connected to a stylist equipped to provide that look thereby providing a source of new customers to stylists. Also, these stylists are nearby physically, from the user's mobile device.

The ability for the system to geo locate and set the list of stylists could come from various sources. The system could receive location information from the internal GPS or cellular triangulation system within the mobile device itself. Such information could be used by the system to map the user. Then, the system could coordinate the stylists which have previously indicated their locations to the system, and only forward the list of stylists to the user within a given set geographic range. In such a way, using any range, the system could indicate that certain stylists, who have previously indicated that they are willing and able to perform the requested style, are also within a certain distance from the user. Thus, a request from Miami is not sent a stylist from Pensacola. Such a suggestion would not be useful to the customer user.

In such examples, the stylist may also send the system and thereby the user mobile device, calendar information such as time and date information 212 for their availability. In certain embodiments, the user may inform the stylist of their availability, instead of the stylist offering open date/time positions. The stylist may also send costs or pricing information to the customer via the network and system 212. The customer could then select, via the user device browser, a stylist they choose 214. FIG. 2E shows an example screenshot of a user mobile device with various stylists to choose from 258. In the example of FIG. 2E, the system indicates how close the stylist is to the GPS location of the mobile device 259. Further, in the example the system could map the stylists on a map to help determine the distance the stylist is from the user device. Another example feature may allow the user to select a stylist and then call the stylist via a button 260 on the mobile device display.

The example in FIG. 2F shows a selection of a particular stylist and/or salon. In this example, the system is able to push information to display on the mobile device, via the network, so the user can view the details of the selected salon/stylist as well as contact the stylist by email 262, view pictures 264 of the physical location, contact the stylist and/or salon by phone 266, or any of various other things the salon and/or stylist wishes to put on their page.

Referring again to FIG. 2A, once selected, the system could send the selected stylist the photos and/or hair recipe previously selected by the customer 216. Thus, the stylist may receive information along with the hairstyle recipe and/or may receive the recipe via a link to access the information to allow for review and preparation before the appointment. FIG. 2G shows an example screen shot of the system requesting the user to approve sending the photos and hair recipe to a desired stylist. The details of the hair recipe could include any number of things, but the example in FIG. 2G shows a before 270, after 272 and celebrity 274 reference for the stylist. Further the detailed hair recipe videos, text, diagrams, etc. may be sent as described herein.

Examples where System Solicits Stylists

Referring back to FIG. 2A, in some example embodiments, after the user selects a style 206, the system could then send the selected style photos and/or recipe to certain stylists within a set geographical region from the user mobile device 220. In such a way, the system can solicit stylists after the style has been selected. Such information could be sent to an email address of the stylist, to a third party website of the stylist, as an SMS text message to their cell phone, to a voicemail of their phone, or to a close environment booking system. In any case, the request is communicated to the various stylists who may respond.

Then, the stylists who receive the request for the particular style, may respond to the request via the network and the system could store their responses 222. The stylists responding may indicate their calendar ability to provide the selected services 224 including costs, and the customer may select from among the stylists 226 who so indicated. The time to respond could be set by the system, and indicated on the communication. It could be quick or the time could be a day or so to respond.

Once the connection is made between customer, style and stylist, the client may book an appointment using a booking platform of their choice that incorporates and/or links to the style discovery and/or selection features to encourage clients to view and choose a style for the appointment. Thus, the system may drive the customer to a third party booking website 230 or internal service that the stylist uses to book appointments 232.

This process ensures that a stylist is equipped with the knowledge and skills to provide the client the look they requested.

### History Examples

In some embodiments, the system may also utilize client appointment history, client style history, retail product suggestions, tagging and purchasing, sharing, and other features described in detail below.

In certain example embodiments, the system is able to retain historical records for the customer users and stylists and/or salons to later refer to. For example, the system may record the client profile image, the date and the chosen style for a given appointment. The stylist may also keep notes of that appointment, for example, what products were used, what techniques were used if out of the ordinary, etc. In this way, when a customer user tells the stylist and/or salon to repeat the style from a previous booking, the stylist and/or salon can then refer to the historical details and notes. In some embodiments, either of clients and/or stylists may upload an image of their finished look and keep it and compare it to the chosen look from the app.

FIG. 2H shows an example of an appointment history screenshot GUI for a given user. In the example, the dates 280 of previous appointments for a particular customer user 282 is shown alongside the particular style “Revolver—27” 284 that they received on that date 280. In certain embodiments, the system may link the style icon/photo 284 to the hair recipe for that style. In this way, the salon and/or stylist may access the previous styles even if that particular salon and/or stylist actually performed the previous style or not.

### Other Example Embodiments

Besides the two general ways FIG. 2A describes how the system can flow, it should be noted that other ways of coordinating stylists could be done as well in different embodiments. For example, the system could allow the user to select their favorite stylist first, and then the system could push to the user mobile device the styles that the particular favorite stylists is able and willing to perform. In such an embodiment, the customer user is able to stay with a stylist and/or salon they prefer, even if the style selection is limited.

### Stylist Suggestion Examples

In certain embodiments, the systems and methods here may work in yet another way. In certain embodiments, the stylist/salon can find a style and send it to their customer users. In such a way, the customer users could receive suggestions from one or more than one stylist and be prompted to book an appointment with that stylist.

Thus, in the example of FIG. 2B, instead of pressing Get It! 209, the stylist chooses to share the option to send the chosen style to a friend/client. Doing so may automatically populate an email draft with the picture and a link to the system and text that says, for example, “I found a style you might like. Download the stylez app and make an app′t.”

Such communications may also include edited text. For example: Hi Cory, I haven't seen you in a while but found a style you may like!” This can be shared the same way through social media platforms as described above.

### Style Discovery Category Examples

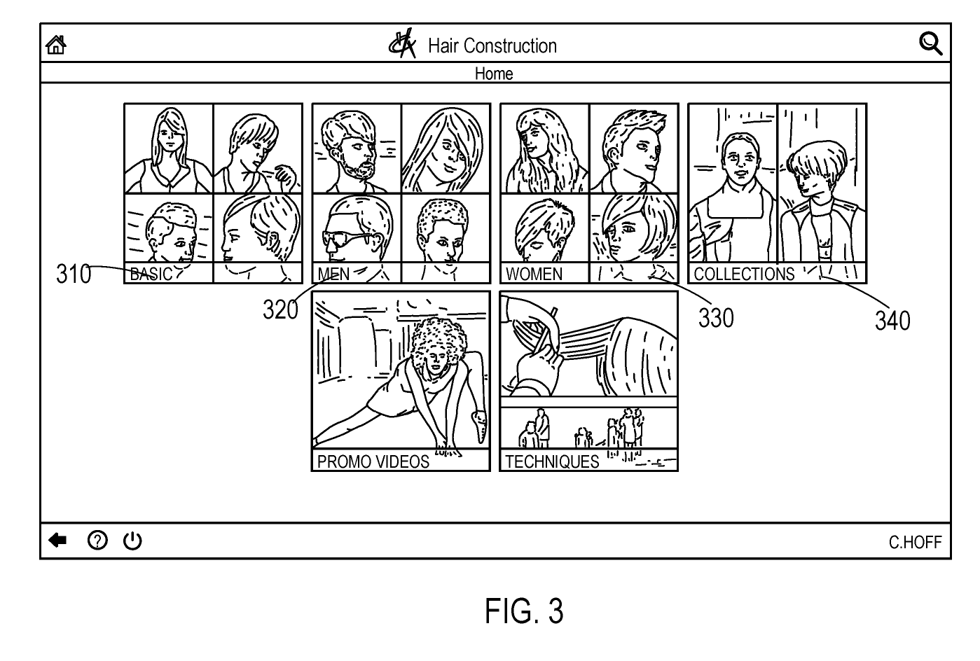

Referring back now in the process to the style selection itself, the styles and looks displayed to the user for selection may be comprised of images/videos of professional models photographed in photo shoots or those shared by users of the application. An example of the set of styles displayed and selectable by a user is discussed in further detail with respect to FIG. 3. The plurality of style photos are categorized and tagged with a plurality of descriptors, and may be associated with a plurality of related style ideas. Each style may include a variety of images/video providing views of the hairstyle from multiple angles.

After login, for example, a main menu is displayed at FIG. 3 where a user may choose between main categories to select including Basic 310, Men 320, Women 330, Collections 340 Promo Videos 350 and Techniques 360. Any of various categories could be used and selected here, and these examples are not intended to be limiting. In certain embodiments, a user may select favorite styles as a category to save styles or favorites may be selected by the application administrator. These categories may break down into sub categories as well. For example, the women 330 group, if selected, may display any of various sub groups such as Updos, short, curly, color, long, etc.

The images displayed in the category menus may be updated as desired by the application administrator or by users who have experienced the category styles. Photos could be sent to the system with a suggestion as to which category they fall into and a system administrator could use the newly added photos where it makes the most sense. Additional categories may be displayed in the main menu based on any desired categorization. The menus and labels may also be customized by the user.

### Style Sub-Category Examples

Referring again to FIG. 2B, in this example, a sub-menu is displayed following selection of the Women category. A celebrity style example is displayed adjacent to a model having the corresponding celebrity style in order to provide the user another perspective on how the style looks. A star 240 icon may be selected to allow a user to highlight a particular celebrity which may be saved for later viewing and/or selection. Any manner of celebrity selection could be used, the star icon being only illustrative. The user may, for example, search 244 for a specific style by inputting keywords to search. A row of icons 242, 244, 246, 248, 250, 252 may be displayed to provide navigation access to other menus/screens. The system may provide illustrations of a sub-category carousel of options 241 within the selected women category such as color, curly, long, etc. that may be swipable to rotate through the available sub-categories.

When a sub-category is selected, the display at FIG. 2D may be provided to the user indicating names 254 and pictures 256 of various sub category styles. A vertical scroll screen may allow a user to search for styles within the previously-selected sub-category. In general, the display example in FIG. 2D is populated by similar styles, such as all short-haired women's styles, or long haired men's styles, for instance. However, random search options are available that provide styles different from those shown. These random options may be driven by the system based on any number of factors. For example, a certain style may be trending as popular, so the system suggests more popular examples to choose from. Additionally, the system may tap into the user's social network to see what trends the friends or contacts of the user are supporting. Suggestions may be based on sponsored links, which showcase a particular salon product or device for styling. Any number of sponsored links and/or ads could be included in the suggestions.

Additionally, in some embodiments, users are able to select, in this example by selecting a ‘heart’ icon 248 to add the style to their favorites for later reference. Any manner of favorite selection could be used, the heart icon being only illustrative. Additionally, the name under each picture may be the name of the collection, and the number used refers to the model pictured.

Referring back to FIG. 2B in more detail, the example illustrates how a user may select one particular style where a larger version of the style shown in FIG. 2C, a sub category screen may be displayed. A scrollable/swipe-able carousel 207 may be provided to display different angles of the hair, provide style ideas and/or product suggestions relevant for the displayed style. When one of the images is selected by the user, the selected image may appear in the larger portion of the screen.

### Sharing Examples

As shown in FIG. 2B users may press the share icon 208, which may enables them to share or email the selected style(s) within their social networks, through email or any other messaging protocol such as SMS and the like. The ‘Get It!’ icon 209 may be selected when a user shares the style with a stylist.

Thus, certain embodiments include sharing options selectable by the user after selection of a share icon which are not limited to those displayed. Thus, customer users may load third party social network credentials into the system and/or otherwise provide a way of accessing their social media accounts. In this way, the system may access their third party social media accounts and upload photos, style information, map/location information, product information, etc. to the individual account of the user.

Users may share the styles they have selected as their favorites, and choose to let their social networks view, comment on and/or vote on the selected styles. They may also share the stylist/salon that they have chosen, share a picture of the end result, or share any other information provided within the application on their social networks or over any other communication network.

Further, in certain embodiments, the system may be able to download information from the social media site for which the user provided access. For example, the system may be able to download or access friend lists, preferences indicated on the site, metrics of use of the site, or other social networking information which it may use to tailor products, advertise, or share information.

The social network and communication websites could be any of various sites such as Facebook, Pinterest, Tumblr, Twitter, Instagram, etc. Any future social network or website in general could be linked here in order to allow sharing, posting, etc. Some embodiments may include a confirmation page after sharing has been performed. The user may also include additional text/voice/audio/video input accompanying the shared item.

Referring to FIG. 2B, the share icon 208 may be used. The system may then upload the information to the designated social networking site.

### Hair Recipe Examples

Some embodiments of the invention provide hairstyle recipe instruction allowing users to learn techniques, learn how to create entire hairstyles, haircuts and hair colors on any mobile device or computer. As discussed above, in certain embodiments, when a client books an appointment with a stylist for a selected hairstyle, the stylist receives this booking information, and also may receive access to the hair recipe to ensure the stylist can acquire the knowledge and skills to provide the desired look. The hair recipe may be incorporated into the mobile device application or as a standalone application. Embodiments of the hair recipe are discussed in detail below.

In certain embodiments, the systems and methods may be used to provide maintenance videos, instructions, updates and information to customer users so they can maintain their look when not in a salon, not only to salons/stylists.

As described in detail below, the different pictures, video, written description, diagrams etc. all make up different data that the hair recipe incorporates in order to instruct the stylist. This data for the hair recipes may be stored at a central repository or cloud storage and streamed to users. Data may also be available for individual users to download to their own device. It may be allowed to stay on the mobile devices, or may be available for rent, with a limited availability of time before the recipe is removed or deleted.

A hair recipe may be any of various instructional content that may be distributed through a various types of media including, text, video, diagrams, audio, photos, etc. via the networked computers. The hair recipe instructs stylist/hairdressers/salons from the level of individual technique to entire haircuts, hairstyles and hair colors. Each recipe may provide a plurality of layers of instructional content.

A hair recipe video may begin with photos from the photo shoot, showing different style ideas, different angles of the hair, etc. Additionally, hair extensions, hair tools (curling irons, etc.), hair ornaments, jewelry, clothing, etc. are also utilized in these photos, providing users with ideas or inspiration for how they can wear the hair. These are often used for advertising, selling or promotional opportunities. Thereafter, the hair recipe to create the style may be shown.

The hair recipe may include video of a hairdresser or barber styling hair on a model or a mannequin head. The videos also include overlays of head diagrams with corresponding text instructions for that particular section, showing the hairdresser step-by-step how to section the hair and the techniques to use in each section of the hair to create the look.

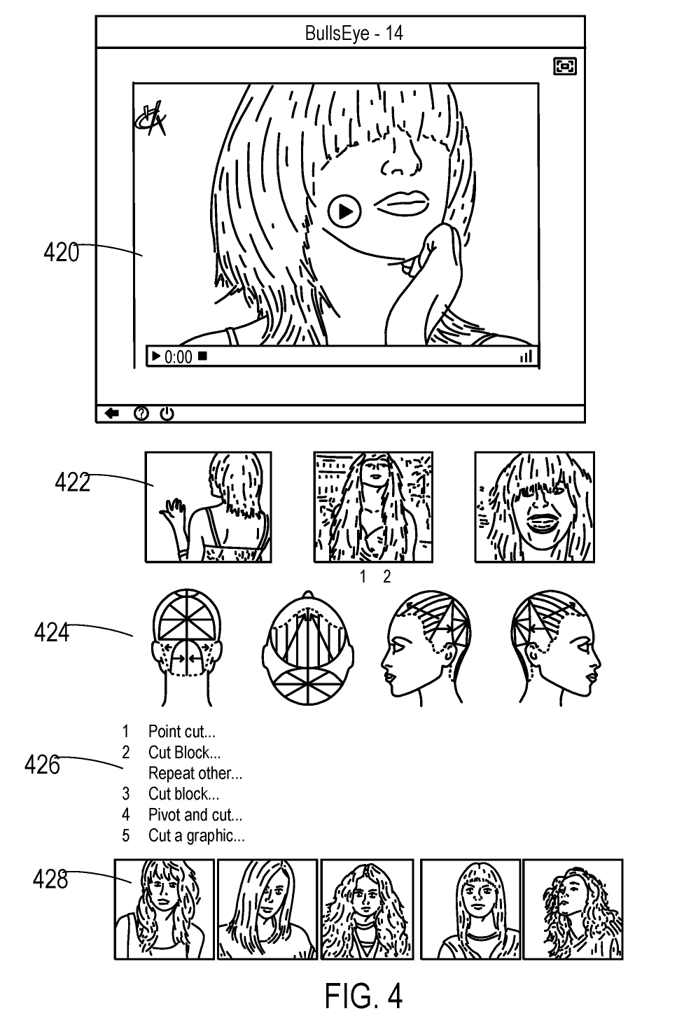

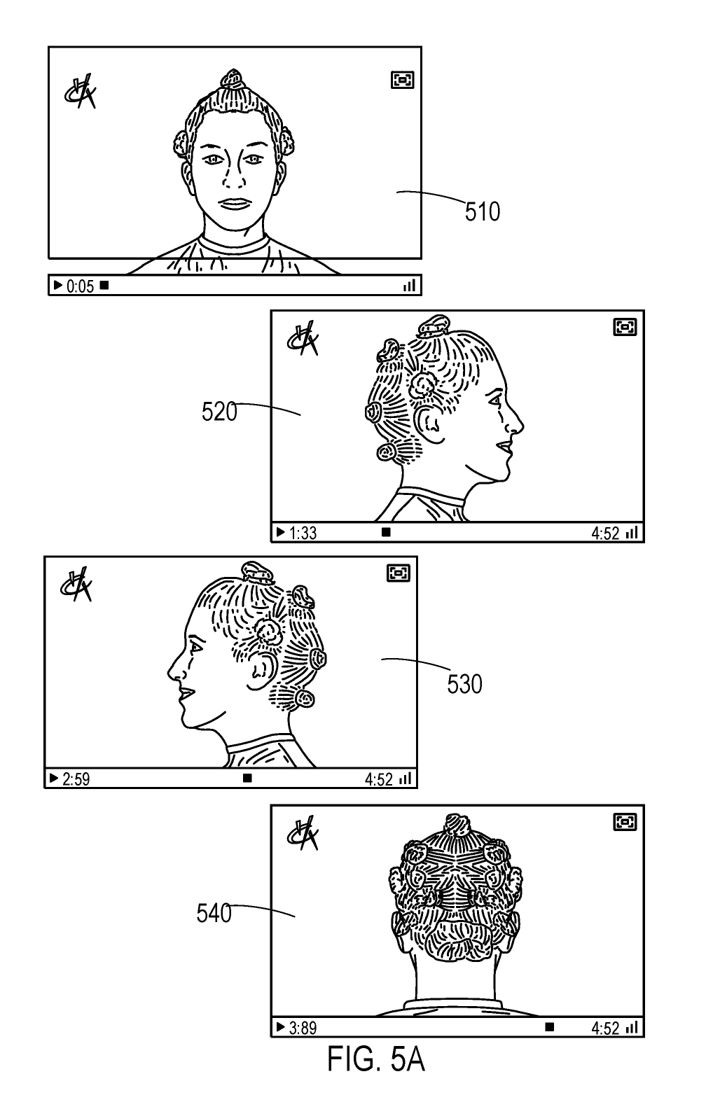

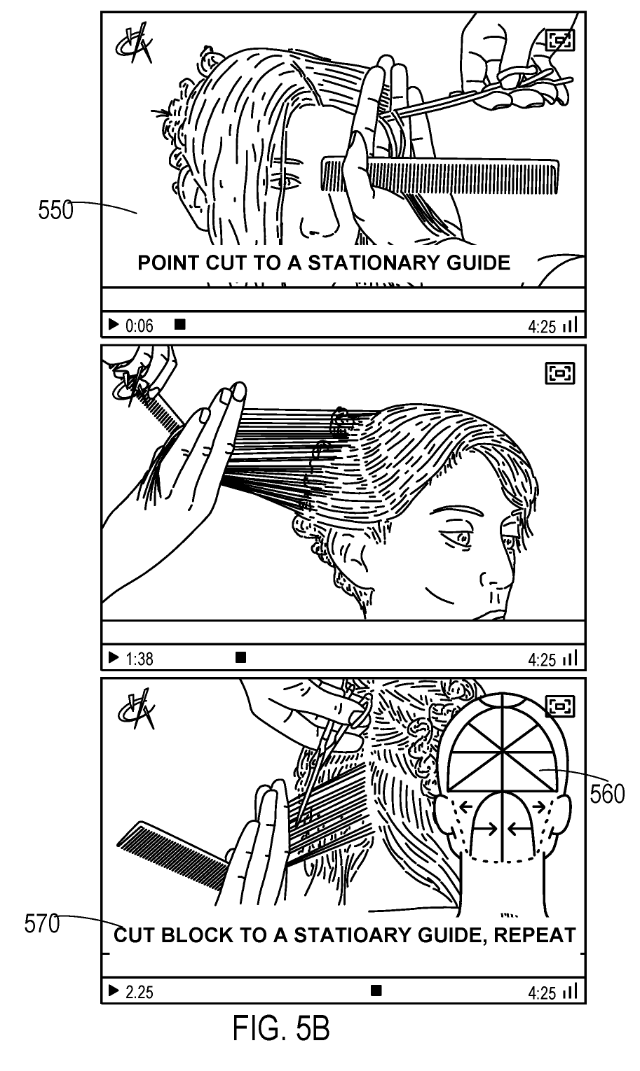

FIGS. 4, 5A and 5B illustrate some example implementations of different hair recipes. In FIG. 4, a video 420 is displayed of a model rotating with the desired look to provide a complete view of the entire head. Other style ideas and/or angles may be shown overlaid within and/or adjacent the video 422. Likewise, a head diagram/blueprint showing how to section hair may be overlaid and/or shown adjacent the video 424. Text instruction corresponding to the head diagram 426 is also provided where each step in the text may contain a link to other instructional material, such as a specific technique video. Related styles may be shown overlaid and/or adjacent the video 428. In the video begins with a plurality of images of the hair style including different angles, style ideas and associated products.

Depending on the particular style, a stylist may section the hair on the head according to the head diagrams, or blueprints. Different techniques are used in each section, usually done in chronological order from Section 1, to Section 2, etc. The associated techniques may be listed in order and correspond with each section. When followed correctly, the end result is a look similar to what is seen in the photos of each style. Variations may be used as more experienced hairdressers and barbers are able to customize each look for their client's preference, personal style, bone structure, hair type, etc.

Users not only view a model with a desired look, but are able to view the look from a plurality of angles and are provided the hair recipe enabling a stylist to create the look. In FIG. 5A a video plays with a 360 degree view of how hair should be sectioned, including a front 510, profile 520 another profile 530 and rear 540 angles shown in the example figure.

In FIG. 5B, the video shows step by step instructions on how to style the hair 550. Further, in 5B, an overlay of the head diagram is shown 560 as well as an overlay of text instruction 570. The term overlay is used herein to indicate that video is shown along with other elements at once such as text, and not necessarily that multiple elements are directly on top of one another. The head diagram may be highlighted, by colored lines, for example, to indicate to the viewer which section of the head diagram is being worked on, techniques, color versus cut, and so forth. Text overlay may also be displayed indicating the steps to perform within that section. Video of a hairdresser performing the step is shown may be shown concurrently. For instance, the blueprint and text may appear and disappear as desired to provide detailed instruction at one point and a better view of the head at another point while video of the action to be performed is shown. Accordingly, the blueprints and/or text may appear as a reminder depending upon the length of time or complexity a section takes to complete. The process repeats for each section to be worked on according to the hair recipe. Furthermore, products used within the recipe such as hair cutting tools may be purchased through an overlay link of the video as described below. The video may finish, with a sequence of images showing different angles of the hair style, different style ideas and product suggestions.

In some examples for the display, when a link is selected, such as an individual technique selected from the text instructions accompanying a head diagram step. Hair recipe and individual technique videos may be performed on models, mannequin heads and virtual models. Videos may also include promotional videos of stylists working backstage, on stage, during retreats, in classes and seminars, etc.

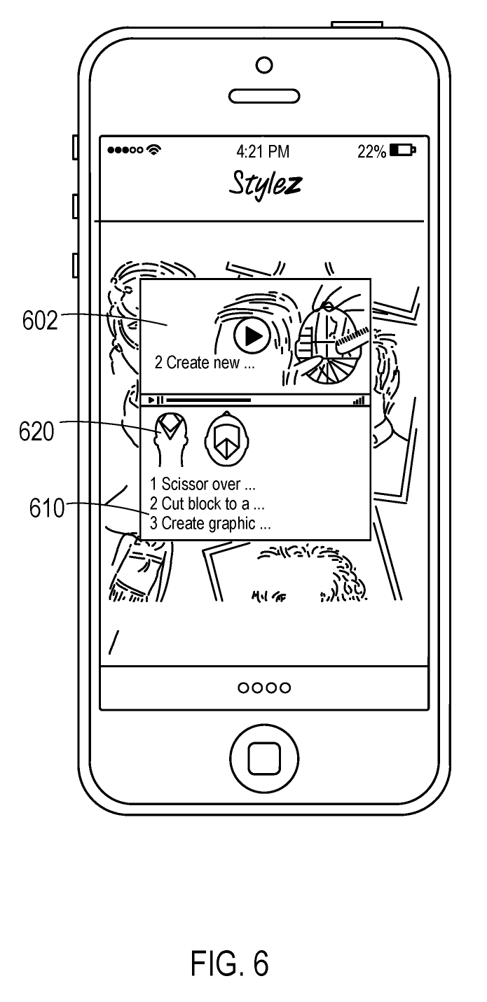

In FIG. 6, the example screenshot shows a mobile device embodiment of the hair recipe instruction. In the example, a video may be played 602 with the hair recipe text 610 and figure overlay 620 as well. The hair recipe and instructional video may be viewed by the customer user and/or the stylist via such mobile devices. In such a way, in certain embodiments, the user customer may learn how the styling will progress, and the stylist may learn the techniques to implement the style.

### Appointment Request and Booking

Users may contact and connect with a salon, stylist, student or professional directly through the system, mobile device and applications. The mobile device may communicate contact information, personal profile pictures, appointment details request, the chosen look/style, and provide access for the stylist to view any corresponding instructional videos and hairstyle recipes for the appointment. Each user may also be provided a picture portfolio including representative work of a stylist. The stylist may also be provided personal pictures of the client in order to easily identify the client, to view a history of the styles the client has previously had, and to determine the client's hair type, etc.

In some example embodiments, users may make an appointment and request a date and time with a specific stylist. In some embodiments, the stylist can push a list of open dates and times for a user to choose from.

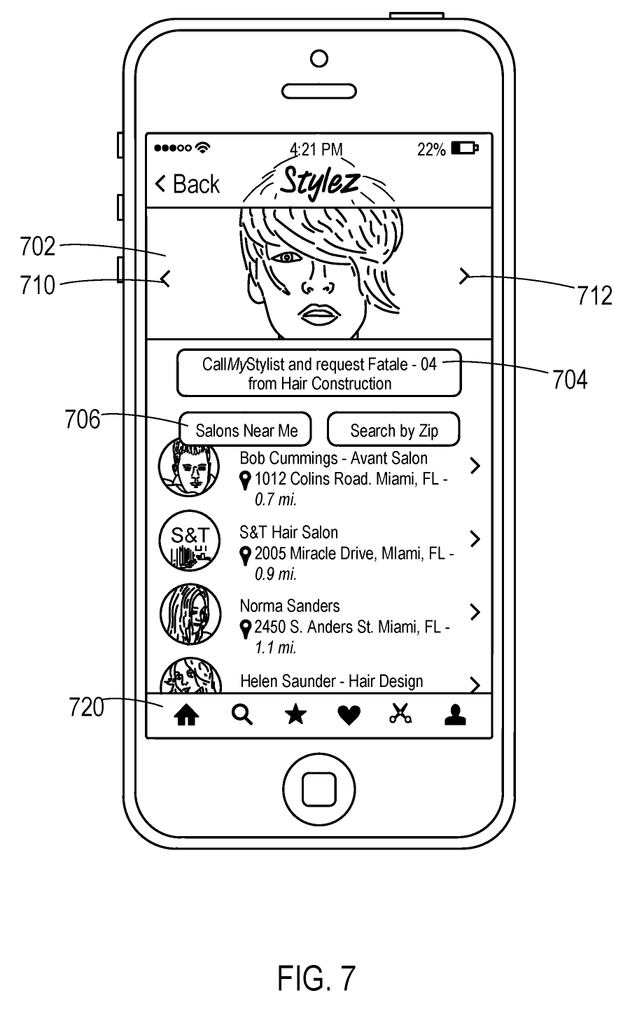

In certain examples, a user may select a style and request a list of stylists who have indicated that they are willing and able to perform that style. In certain embodiments, the system may also limit the list based on the geographic location of the user and the stylists. In such embodiments, the user may select the Get It! icon from FIG. 2B 209. After selection, a stylist search screen may be sent from the system, as illustrated in the example in FIG. 7.

In FIG. 7's example, the selected style is shown 702. In some example embodiments, icons 710 and 712 may allow a user to scroll horizontally to select other styles. In certain examples, the style change corresponds to salon and/or stylist changes as well.

In any case, the system can allow the user to view a list of salons and/or stylists within a set geographical distance near them 706 as disclosed in this disclosure. Certain embodiments allow the user to select a zip code to search within.

Once a stylist or salon is selected from the list, the screen may allow the customer user to contact/call their own stylist to request an appointment based on the selected style, which in the example of FIG. 7 is called “Fatale—04” 704.

Further, as otherwise disclosed, certain icons 720 may provide navigation to other screens as described in this disclosure.

In certain embodiments, a user may not only book a time/date to receive a style for a specified look, but also for other services provided by the stylist. Appointment reminders may also be displayed at predetermined intervals to remind a user and/or the stylist of their booked appointment. A calendar interface may be provided for the appointment features. A note taking feature may also be provided for the user and stylist to input notes related to any of the information stored in the mobile device such as styles, stylists, booking details, etc. For example, a client may input notes with special requests or a personal message for the stylist in the appointment request, which can be messaged to the stylist. This message could be through any of various ways including but not limited to SMS text message, email, social media updates, phone voice, etc.

In some example embodiments, after a user selects a stylist/salon and style, a user interface such as shown for example in FIG. 2F may be displayed in the user device. The example in FIG. 2F shows details of a salon/stylist profile 264, and allow a user to navigate to view a corresponding online portfolio, contact information 262, user reviews, as well as functionality to make an appointment 266 with the requested stylist for the selected style. The user may view a stylist's calendar and choose a date and time for the appointment or may select a time and wait for confirmation from the stylist. A call may be placed to the stylist for booking, via email or SMS messages or via any other communication method.

The stylist profile may include a profile image, professional and educational information, personal statement and services provided. The online portfolio may be formed of any of audio, video and image data showcasing stylist work, inspiration, workplace images, or any other media to market the stylist to the user. Social media link s may also be displayed for user selection. The stylist profile is viewable within and outside the mobile device application.

### Communication Examples

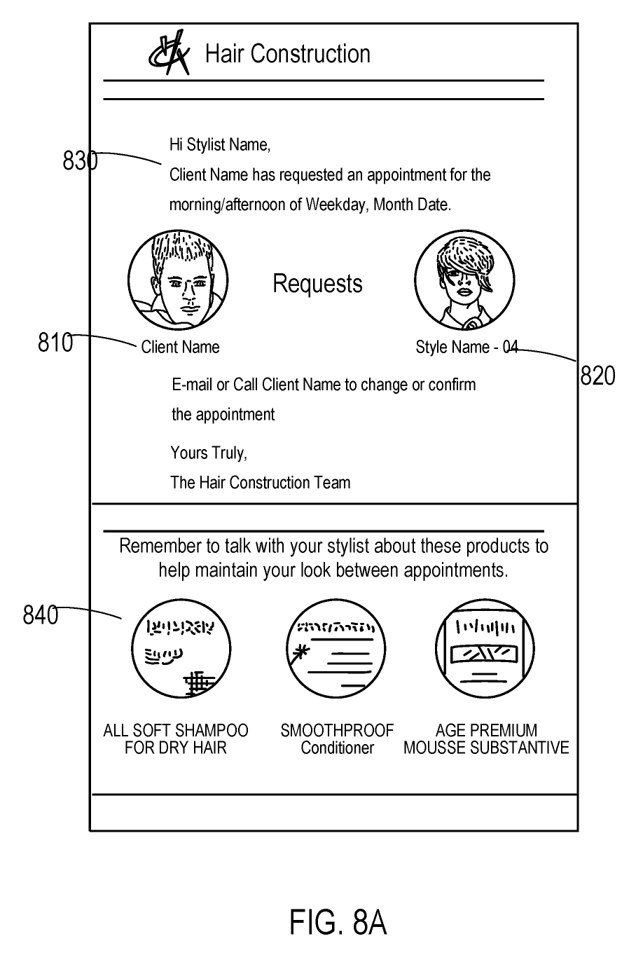

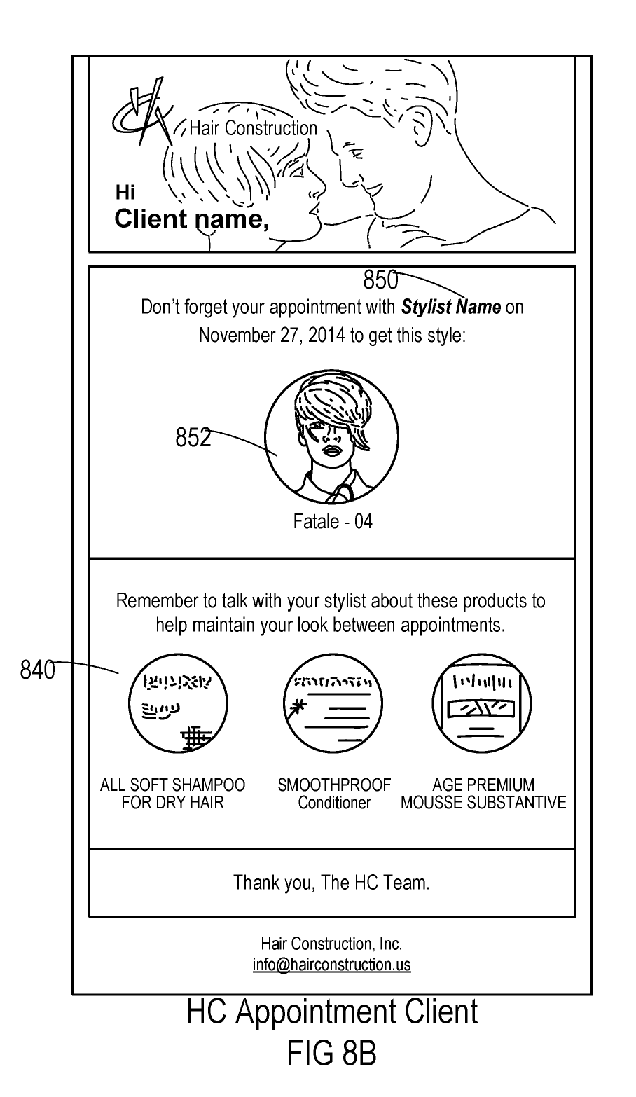

After booking an appointment with a stylist, a confirmation page such as in FIG. 8A may be created and sent by the system to the customer and/or stylist. Such a communication/display may also confirm a specific date and time previously selected. The stylist may receive an appointment request and confirm booking of an appointment, if not automatically confirmed via the mobile device. The stylist may also receive the selected hairstyle information selected by the client and may be provided access to the hair recipe and instructional materials necessary to teach the stylist how to create the hairstyle, along with different style ideas. For example, FIG. 8A illustrates an example notification received by a stylist of an appointment request. In the example of FIG. 8A, a client name 810 shows up and a stylist name 820 as well. The system takes the information for the details of the request 830 and places it into the communication. In certain embodiments, cross promotional information 840 may be added to the communication. In such a way, correlated products to the style may be advertised, sold, suggested etc. as described below.

In certain example embodiments, the client user is able to edit the request. Such a communication may be via any of various forms of communication, for example but not limited to an email, SMS text, social media update or message, message post on an internal website, or any of other various ways.

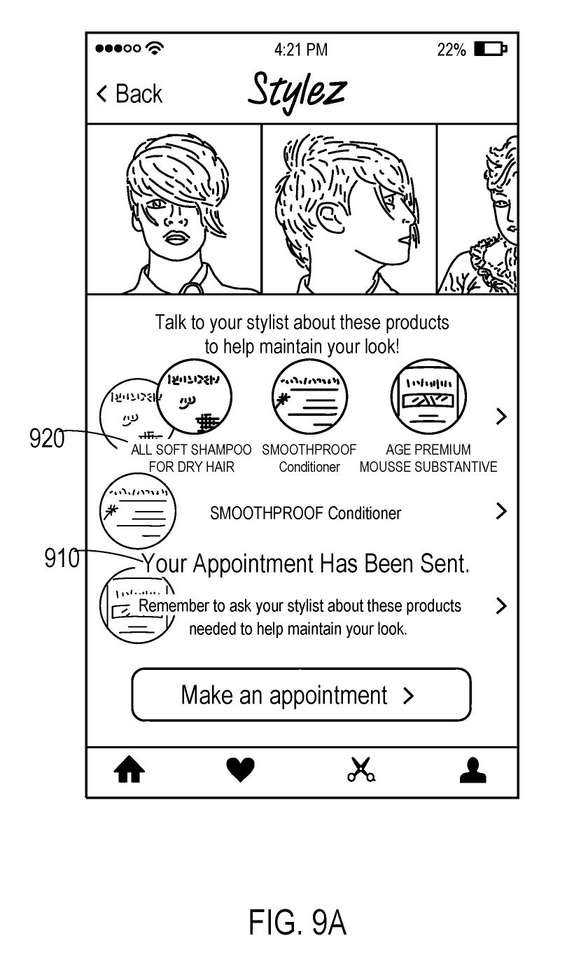

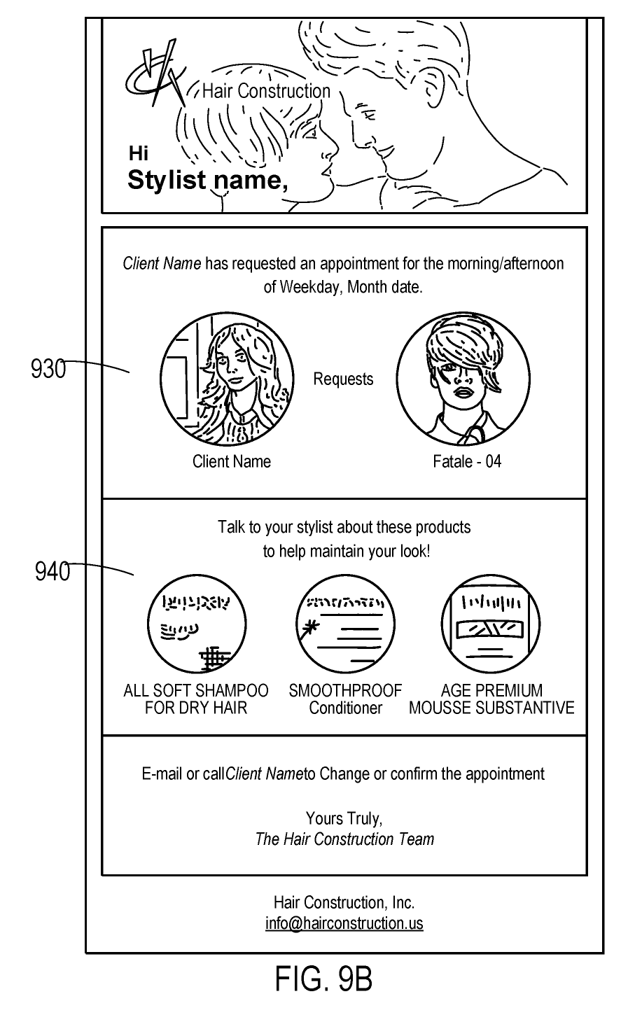

FIG. 8B shows an example reminder communication. In this example, the system is able to generate a reminder communication to a user who has booked an appointment. The reminder includes details on the Stylist Name 850, the name and photo of the requested style 852. The system is also able, as discussed below in FIG. 9B to generate cross promotional information 840 in FIG. 8B for relevant products that the user may enjoy.

In certain example embodiments, a history of appointments may be stored for user review and/or stylist review and may include the dates, stylists, salons, styles, products, techniques, user profile, stylist profile and portfolio and any pictures taken of the end result compared to the style requested.

### E-Commerce/Product Purchasing Examples

Stylists and clients may view and order products that correlate to specific hair styles, photos, recipes, etc. Thus, a hair style displayed may also be shown with accompanying products and/or accessories matched with the style. The products may include those necessary to create a specific hair style such as hair coloring and/or hair extension, as well as tools like the curling iron used to create the look. Other products such as the clothes or other fashion accessories worn by the models/celebrities in the images or that fit the hair style may also be displayed and offered for purchase through the mobile device application. Companies may advertise specific products to clients based on any number of factors such as but not limited to, their accessible profile, the application usage and history, friend/contact activity, and sponsored campaigns.

Further, the example in FIG. 9A shows a communication in the internal system. In the example of FIG. 9A, not only is the appointment confirmed 910, but the system is able to recognize, correlate, and target advertisements to the user. Thus, an ad 920 for a particular product that is related to the requested service may be located and pushed to the user. In certain embodiments, the user could select a particular ad and be taken to a portal where that product is offered for sale. In such a way, a user could be both confirm an appointment and also actively shop for related/targeted products.

FIG. 9B shows another example of a confirmation communication as discussed above regarding FIG. 8A, but also another style of targeted advertisement. In this example, the appointment details 930 are pushed to the client and/or stylist. Also, the system has correlated particular products 940 that the system administrator has requested be advertised extensively, or are somehow related to the style requested by the customer. This correlation can take place before the client chooses a style, or after, depending on a number of possible variables. The system could correlate the geographic location of the user and suggest products suited to their location, could push products that are available for purchase at the salon they have booked, could push products that the system knows can be shipped before and/or after the style is performed.

### Profile Examples

Some embodiments of the invention provide users with an online platform or home website including features such as client management, client booking, an online portfolio, visual/digital resumes, product purchasing and sales, among other features. Such profiles may be for stylists/salons and/or customer users.

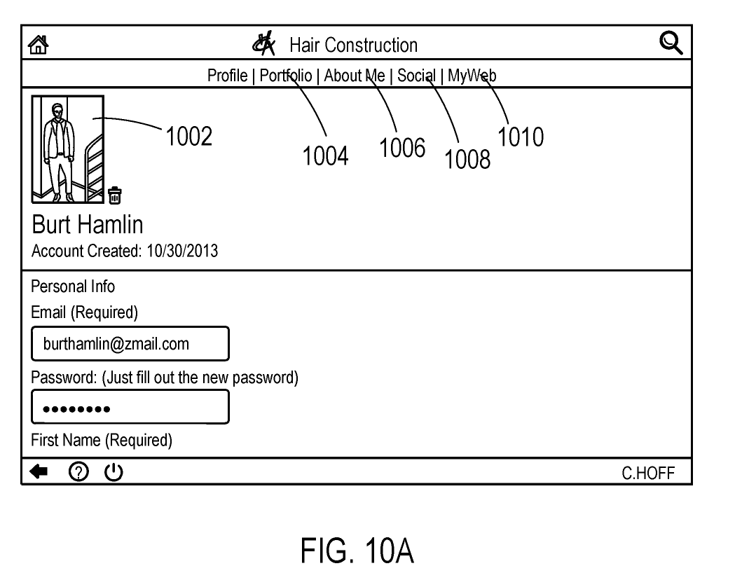

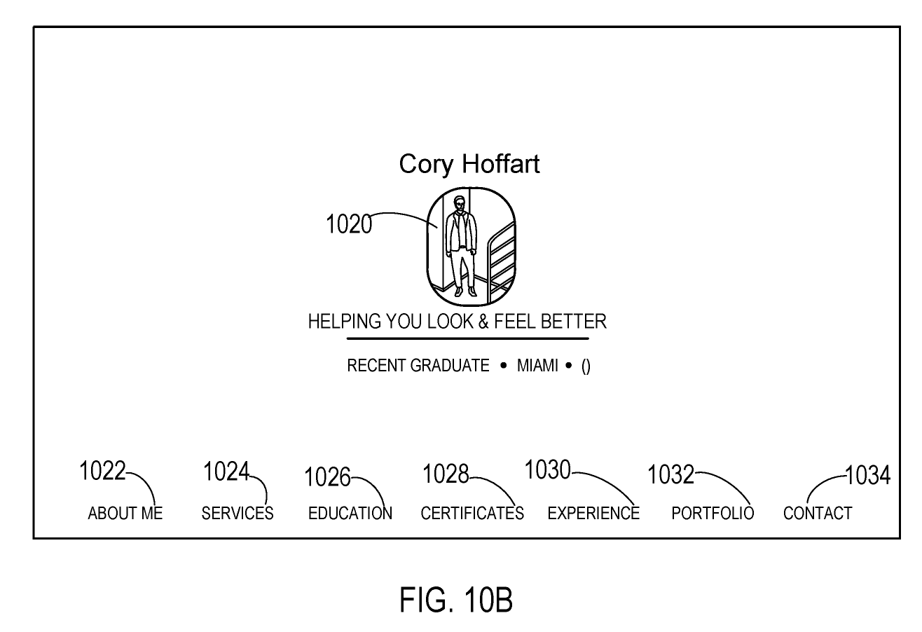

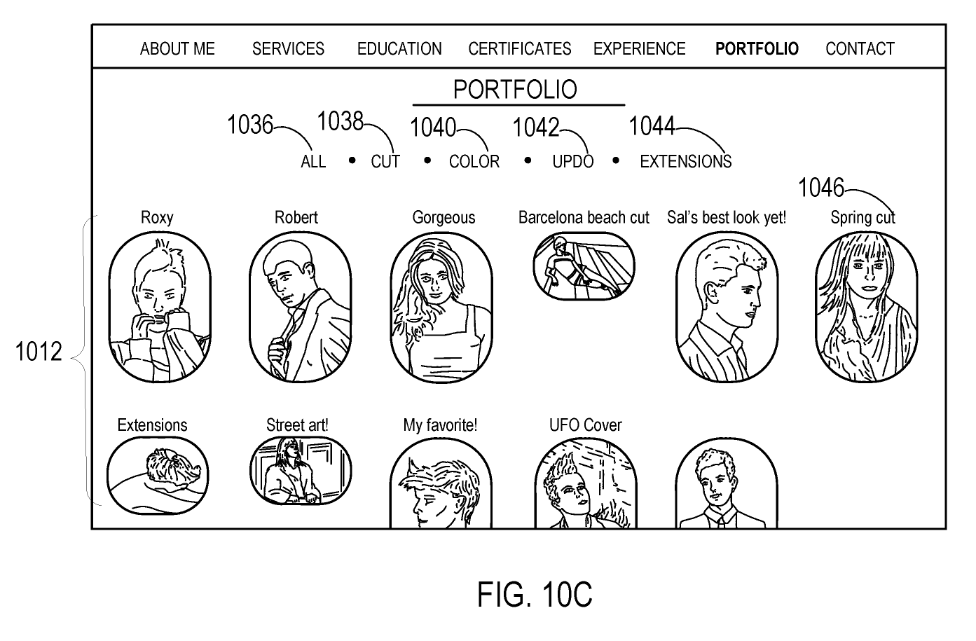

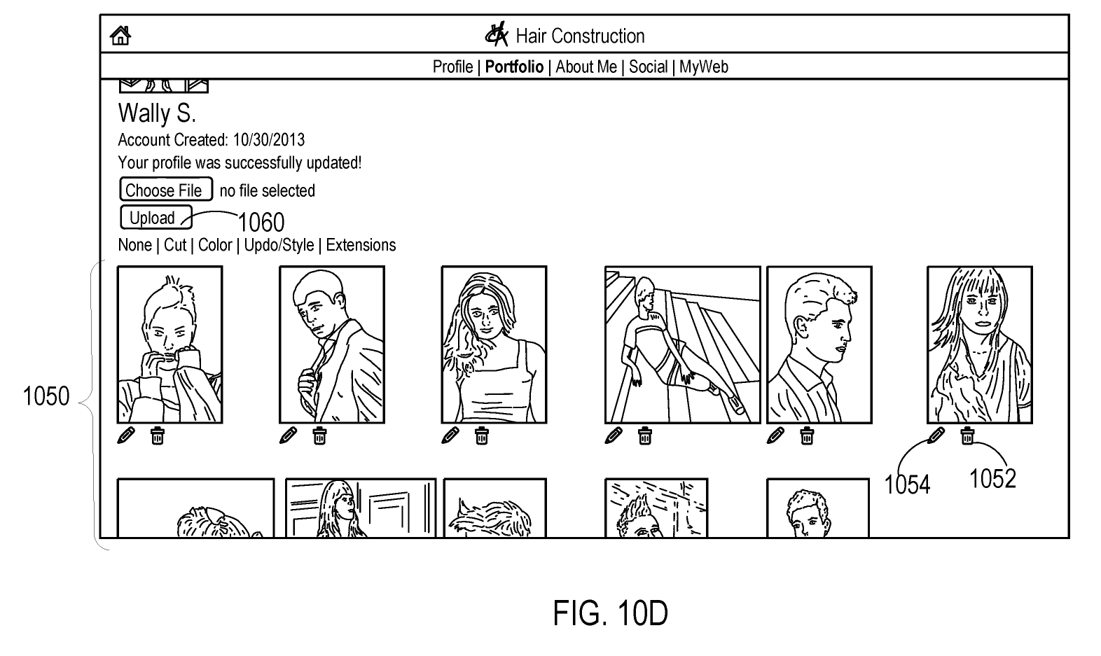

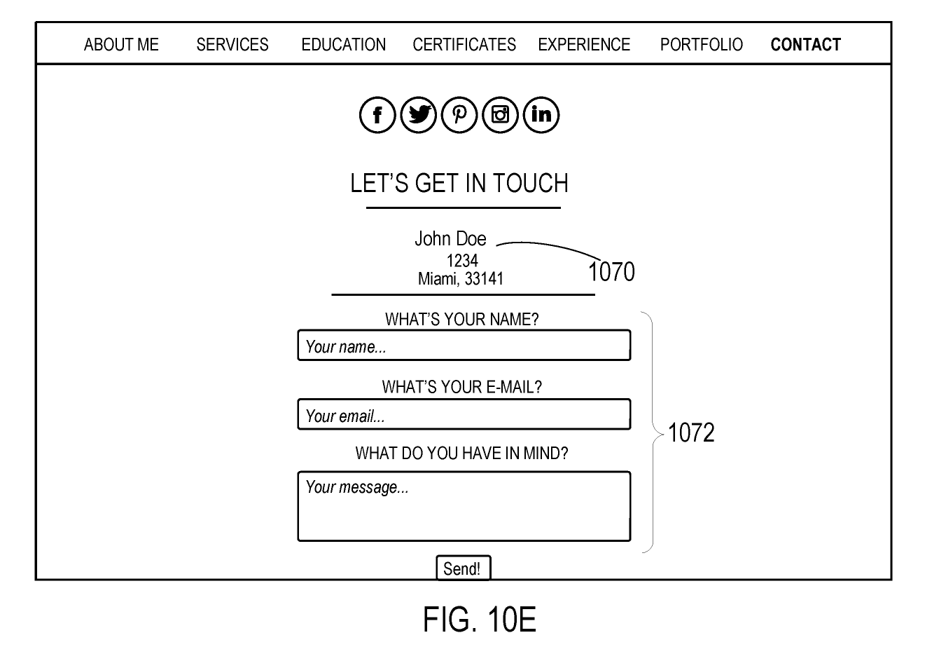

FIGS. 10A-10E illustrate some example implementations of GUI interfaces and information a user may enter in creating an online presence such as a profile for viewing by clients such as those searching for a stylist using the mobile device application.

FIG. 10A shows two example screenshots of a general user profile. Such user profile pages can be created by customer users as well as by stylists. In such a way, customers may learn more about the stylists on the system and stylists may learn more about the customers and potential customers as well.

In the profile page example in FIG. 10A, the user has uploaded a photo 1002 and associated with their online account. The example profile page also shows various features that a user may utilize to add information to the profile and also share the information. The portfolio button 1004 the about me button 1006 the social medial button 1008 and my web buttons 1010 can be linked to various pages that a user can upload information about themselves 1006, link to social media 1008 accounts for sharing purposes and even utilize an internally created social media page my web 1010.

FIG. 10B shows an example website homepage after the user has created the profile. This example is one which may be used by a stylist and/or salon. Such an example shows the stylist's information, 1020, and displays links to their professional information such as for example, about me 1022 services that they may perform 1024 education 1026 any professional certificates 1028 experience information 1030 portfolio photos 1032 and even contact information 1034.

FIG. 10C shows an example embodiment of a user's portfolio photos 1012 to their own account. These photos could be from any source, and be uploaded in order to refer to by a stylist at a later time, for example as discussed in FIG. 10B. For example, a customer user may want to upload photos that they like, are inspired by, think other may be interested in, etc. Stylist users may upload photos of their previous work to show potential customers. The photos can be categorized by the user, tagged as having a particular feature, can be moved and deleted as needed by the user.

Continuing with the example in FIG. 10C, after the appointment, both the stylist and the user can upload photos of the finished work and compare them alongside pictures of the style provided by the application. These images can be shared via email, online and via social networks. Clients are able to share their new hairstyle with their social networking friends while simultaneously providing stylists with a new marketing opportunity to showcase their work, thereby encouraging stylists to be more engaged and educated.

When another user visits such a page, they may scroll through, view, and tag photos that they like for whatever reason. In the example of FIG. 10C, the page allows users to select categories such as all, 1036, cut 1038, color 1040, Updo 1042, extensions 1044, etc. Any of various categories could be used to categorize the photos so others can find what they are looking for and users may group the photos logically. Further, the example screenshot shows a short explanation for each photo, for example “spring cut” 1046. Then later, they can access these tagged photos and share them, view them, or send them to stylist or other customers.

FIG. 10D shows a page allowing users to upload and edit the photos for their portfolio. For example the photos 1050 are shown with icons to delete a photo 1052 and edit 1054 information about a photo. The user may upload 1060 a photo using the options on the page.

Personal information, professional information, services provided may be input by a user. An online portfolio may also be uploaded to showcase work performed, inspiration or other images/video/audio to market a user to clients. Social media and other links may also be provided. Calendar functionality for booking may be accessed and products may also be browsed and purchased from the site by users and clients.

FIG. 10E shows an example screenshot of a user profile Contact page on a user's own personal website. In the example, contact information 1070 is shown along with input windows 1072 where a user can fill in communication information.

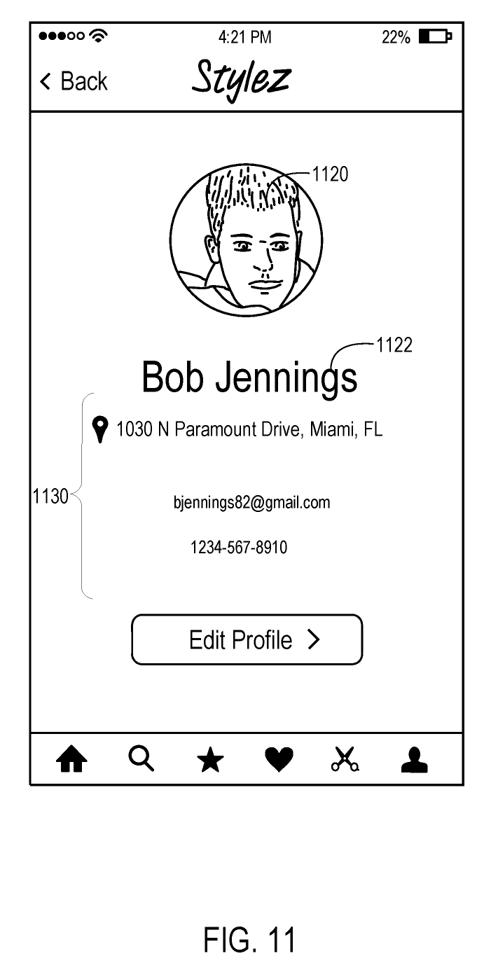

FIG. 11 shows an example user profile page. As disclosed above, the user profile can include any of various information for a user. For example, a user profile may include a personal photo 1120, name 1122, contact information 1130, social networks used, hobbies, friend lists, appointment and hairstyle history, photos of their past hairstyles, favorite photos and the like.

### Retail and Professional Product Tagging Examples

In certain example embodiments, the uploaded photos discussed in FIGS. 10C and 10D may be tagged. A tag may be associated with a particular product. So for example, if a stylist knows what hardware (size scissors, clippers, blow dryer, curler, flat iron, etc.) was used to create a style, they can indicate so in the tags. Further, if certain products (dye, shampoo, conditioner, hairspray, gel, etc.) are used in creating the style, information about them may be added. In such a way, a stylist or user can examine a photo and view the necessary products and hardware to implement and maintain that style.

Thus, for example, a stylist could tag a photo of curly hair they created with a 12 millimeter curling iron from Enzo Milano used to create the look. Users who view this look may also view the photo tag and if they select the tag, they may be directed to purchase the tagged product, read more information on the product, see who else is using the product, or see what other styles may be created using the product.

### Data Examples

In some embodiments, the system may enables salons, stylists, product companies, schools, product distributors and other business partners to connect directly to users through the application based on data gathered on the application related to the user. For instance, a product company can promote a monthly sale directly to their customers through the application via any of email, social media, push notifications, and the like. Advertised products may then be purchased directly through the application. Metrics may also be collected in certain embodiments, to allow for companies or salons to count the number of views a particular style receives. Some embodiments allow for a count of how many times a particular style is scheduled in a salon. In this way, trends of hair styles may be catalogued and studied. The data may be shared or sold to style companies or media outlets who use the information to report on trends or dive new trends.

### Mobile Consultations Examples

In certain embodiments, product companies, distributors and product partners may be able to provide expert advice to stylists or clients through use of the application. For instance, if a stylist has a request for a color formula for a client, a company able to fulfill that request can further engage and assist the stylist by communicating through the mobile device application. The company may send promotional and/or instructional materials in response to the request and may provide direct instruction to the stylist through the mobile device. Data collection from use of the application may allow a consultant to indicate trends to a stylist and promote products and/or accessories along with those trending styles.

### CONCLUSION

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

The computer may be a personal computer or other type of work station or terminal device. The structure, programming and general operation of such computer equipment and as a result the drawings is generally well known. The hardware elements, operating systems and programming languages of such equipment are conventional in nature.

The software is stored in a machine readable medium that may take many forms, including but not limited to, a tangible storage medium, a carrier wave medium or physical transmission medium. Non-volatile storage media include, for example, optical or magnetic disks, such as any of the storage devices in any computer(s) or the like. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications.

Common forms of computer-readable media therefore include for example: disks (e.g., hard, floppy, flexible) or any other magnetic medium, a CD-ROM, DVD or DVD-ROM, any other optical medium, any other physical storage medium, a RAM, a PROM, a EPROM, a FLASH-EPROM, any other memory chip, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Accordingly, the specification and FIG.s associated with these embodiments are to be regarded in an illustrative rather than a restrictive sense, and all modifications are intended to be included within the scope of the claims described below. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method of booking a stylist, comprising:
via a server in communication with a data storage and a network,
receiving a plurality of style photos via the network;
categorizing the received style photos;
causing storage of the received categorized style photos in the data storage;
receiving indications from a plurality of stylists, via the network for the stored photos including a geographic location of each of the plurality of stylists;
correlating, via the data storage, each stylist and their indicated photos;
receiving a valid log-in credential and a current geographic location from a customer user mobile device, via the network;
sending the customer user a menu of style categories, via the network;
receiving a category selection from the customer user, via the network;
sending the customer user mobile device the categorized photos to view, via the network, corresponding to the category selection;
receiving, from the customer user mobile device via the network, a selection of one of the categorized photos;
sending the customer user mobile device information, via the network, for a list of stylists, the list of stylists being stylists correlated to the selected photo and the current geographical location of the customer user mobile device based on the geographic location of each of the plurality of stylists;
receiving from the customer user mobile device via the network, a selection of a stylist from the list of stylists; and
sending the selected photo to the selected stylist via the network.

2. The method of claim 1 further comprising, via the server in communication with the data storage and the network,
causing storage, in the data storage, of a hair recipe corresponding to each received stored photo.

3. The method of claim 2 wherein the hair recipe includes at least one of, a name, a video, a diagram and a text instruction.

4. The method of claim 3 further comprising, via the server in communication with the data storage and the network,
sending to the selected stylist via the network, the hair recipe corresponding to the selected photo.

5. The method of claim 1 further comprising, via the server in communication with the data storage and the network,
directing a browser, run on the customer user mobile device, to a booking website for the selected stylist, via the network.

6. The method of claim 1 further comprising, via the server in communication with the data storage and the network,
correlating, via the data storage, the received stored photos and a corresponding style product information; and
sending the customer user mobile device the corresponding style product information correlated to the selected photo.

7. The method of claim 1 further comprising, via the server in communication with the data storage and the network,
determining the list of stylists based on a proximity of the user mobile device current geographic location and the geographic location of each of the plurality of stylists.

8. The method of claim 1 further comprising, via the server in communication with the data storage and the network,
sending the selected photo to a social network website designated by the customer user.

9. The method of claim 1 wherein the selected photo may include a tag with an indication of a product used for the selected style.

10. The method of claim 9 further comprising, via the server in communication with the data storage and the network,
sending the customer user mobile device information regarding the ability to purchase the product tagged to the selected photo.

11. A system of booking a stylist, comprising:
a computer server in communication with a data storage and a network, configured to,
cause storage of categorized style photos in the data storage;
receive indications from a plurality of stylists for the stored photos, via the network;
receive geographic information from the plurality of stylists, via the network;
correlate, via the data storage, each stylist and their indicated photos;
receive a valid log-in credential and a current geographic location from a customer user mobile device via the network;
send the customer user mobile device, via the network, a menu of style categories;
receive a category selection from the customer user mobile device, via the network;
send the customer user mobile device, via the network, the categorized photos to view corresponding to the category selection;
receive, from the customer user mobile device, via the network, a selection of one of the categorized photos;
determine a distance between the geographic location of the customer user mobile device and each of the geographic location of each of the plurality of stylists;
send the customer user mobile device information for a list of stylists, via the network, the list of stylists including the plurality of stylists that were correlated to the selected photo and a chosen determined distance from the geographic location of the customer user mobile device;
receive from the customer user mobile device, via the network, a selection of a stylist from the list of stylists; and
send the selected photo to the selected stylist, via the network.

12. The system of claim 11 wherein the computer server is further configured to,
cause storage, in the data storage, of a hair recipe corresponding to each received stored photo; and
wherein the hair recipe includes at least one of, a name, a video, a diagram and a text instruction.

13. The system of claim 11 wherein the computer server is further configured to,
direct a browser, running on the customer user mobile device, to a booking website for the selected stylist, via the network.

14. The system of claim 11 wherein the computer server is further configured to,
correlate, via the data storage, the received stored photos and a corresponding style product information; and
send the customer user mobile device the corresponding style product information correlated to the selected photo.

15. A non-transitory computer-readable medium having computer-executable instructions thereon for a method of booking a style, the method comprising:
via a server in communication with a data storage and a network,
receiving a plurality of style photos;
categorizing the received style photos;
causing storage of the received categorized style photos in the data storage;
receiving indications from a plurality of stylists for the stored photos;
correlating, via the data storage, each stylist and their indicated photos;
receiving a valid log-in credential and a current geographic location from a customer user mobile device via the network;
sending the customer user a menu of style categories;
receiving a category selection from the customer user;
sending the customer user mobile device the categorized photos to view corresponding to the category selection;
receiving, from the customer user mobile device via the network, a selection of one of the categorized photos;
sending the customer user mobile device information for the plurality of stylists correlated to the selected photo;
receiving from the customer user mobile device via the network, a selection of a stylist from the plurality of stylists correlated to the selected photo; and
sending the selected photo to the selected stylist via the network.

16. The non-transitory computer-readable medium of claim 15 further comprising, via the server in communication with the data storage and the network,
causing storage, in the data storage, of a hair recipe corresponding to each received stored photo.

17. The non-transitory computer-readable medium of claim 16 wherein the hair recipe includes at least one of, a name, a video, a diagram and a text instruction.

18. The non-transitory computer-readable medium of claim 15 further comprising, via the server in communication with the data storage and the network,
directing a browser, run on the customer user mobile device, to a booking website for the selected stylist, via the network.

19. The non-transitory computer-readable medium of claim 15 further comprising, via the server in communication with the data storage and the network,
correlating, via the data storage, the received stored photos and a corresponding style product information; and
sending the customer user mobile device the corresponding style product information correlated to the selected photo.
